(19) United States
(12) Patent Application Publication
(10) Pub. No.: US 2007/0029101 A1
(43) Pub. Date: Feb. 8, 2007

(54) Hammerhead forcible entry tool used to defeat burglar bars

(76) Inventor: Paul Croas, La Porte, TX (US)

Correspondence Address: David A. Walker, 20823 Whitevine Way, Katy, TX, 77450, US

(21) Appl. No.: 11/315,809

(22) Filed: Dec. 22, 2005

Related U.S. Application Data
(60) Provisional application No. 60/595,799, filed on Aug. 5, 2005.

(51) Int. Cl. B25D 11/00; B23P 19/04; B25D 13/00

(52) U.S. Cl. 173/90; 29/254

(57) ABSTRACT

A forced entry tool is disclosed that includes a two-sided hammerhead and provides a mechanical advantage to breach burglar bars and locks, yet is strong and portable. The two-sided hammerhead provides greater positional stability that reduces the necessity to reposition the tool. A two-sided hammerhead is attached to one end a guide rod, while a guide case with handles is encased over the guide rod. A striking base is attached to the guide rod near the end opposite to the hammerhead. The hammerhead is then positioned behind the burglar bars. The case is then moved forcefully over the guide rod, towards the striking the base. This repeated action of striking the base will then defeat the bolts, welds, locks, and bars through leverage and mechanical advantage.

### CROSS REFERENCE TO RELATED APPLICATIONS

This application is a Utility application of prior pending Provisional application Ser. No. 60/595,799 filed Aug. 5, 2005 and incorporated herein by reference.

### BACKGROUND

The present invention relates in general to the field forcible entry devices.

In modem police and military work, especially among special weapons and tactics teams (SWAT), narcotic search teams, as well as fire fighting and emergency rescue teams, it sometimes becomes necessary for such personnel to be able to gain access to buildings and structures rapidly and time is very often a critical factor. To gain access to dangerous and/or burning structures may require breaking through burglar bars by any of a variety of techniques. Complicating the task of forcible entry is the danger of opposition from within a structure: criminals or opponents may be firing weapons at personnel, making rapid entry even more important. As a result, personnel must be able to move rapidly, and to be relatively unencumbered by their equipment.

Historically, the equipment used for breaching barricaded structures been very large, heavy and logistically impractical or even dangerous to use. However, making the equipment more portable so as to be less cumbersome often reduces the utility of such equipment. For example, using a pry bar and sledge hammer may take an unacceptably long time to breach a barrier, even when used by dedicated personnel. Using larger equipment, such as a tow truck using chains, limits the mission to areas accessible by a tow truck and places the operator in unnecessary danger. Accordingly, there is a need for an improved system and method relating to breaching metal barricaded structures.

### BRIEF DESCRIPTION OF THE FIGURES

The present invention is pointed out with particularity in the appended claims. However, other features are described in the following detailed description in conjunction with the accompanying drawings in which:

FIG. 1 illustrates a perspective view of an apparatus shown relative to burglar bars and ready for use;

FIG. 2 illustrates a perspective view of an apparatus shown relative to breached burglar bars;

FIG. 3 illustrates a front elevation view illustrating optional dimensions;

FIG. 4 illustrates a side elevation view;

FIG. 5 illustrates a top plan view;

FIG. 6 illustrates a bottom plan view;

FIG. 7 illustrates protrusions attached to a guide rod to inhibit relative rotation with a guide case;

FIG. 8 illustrates protrusions attached to a guide case to inhibit relative rotation with a guide rod;

FIG. 9 is plan view of a hammerhead with protrusions extending toward striking base, the plan view compared to a profile view of a hammerhead;

FIG. 10 illustrates optional profile views of a hammerhead component; and

FIG. 11 illustrates a pin or bolt to secure the guide case to the guide rod.

While the invention will be described in connection with its preferred embodiments, it will be understood that the invention is not limited thereto. It is intended to cover all alternatives, modifications, and equivalents that may be included within the spirit and scope of the invention, as defined by the appended claims.

### DETAILED DESCRIPTION

The following discussion relates generally to a forcible entry tool or apparatus used to defeat barriers to entry of structures, like burglar bars. Forcible entry equipment used by emergency services or law enforcement personnel engaged in missions to breach protective barriers such as burglar bars has historically been very large and heavy. It is desirable that equipment be rapidly deployable, easily portable and allows users to generate as much mechanical leverage and force against entry barriers as possible. Most equipment that is portable and not cumbersome is also of reduced effectiveness and utility (e.g., a sledge hammer and a pry bar). In the important initial moments of a mission to breach an entry barrier, effective use of pry bars and sledge hammers may be problematic when seeking leverage on a re-enforced door, which may result in unacceptable delays. Especially, if the door uses metal flange blocking, a viable pry point on a re-enforced door may be inaccessible making the task of rapid barrier breach impossible in a timely manner.

Effective breaching tools that are not so cumbersome as to interfere with the movement and safety of personnel are highly desirable. A breaching tool should be amenable to rapid or instantaneous set-up and ready for use within moments even in low light conditions and under stressful mission conditions. The breaching tool should be highly portable and easily engaged with an entry barrier so that the tool needs to be set only once without repositioning, and stays substantially engaged with the barrier until breaching occurs. A breaching tool ideally is extremely durable with contact surfaces and components strong enough to handle high-shock stresses.

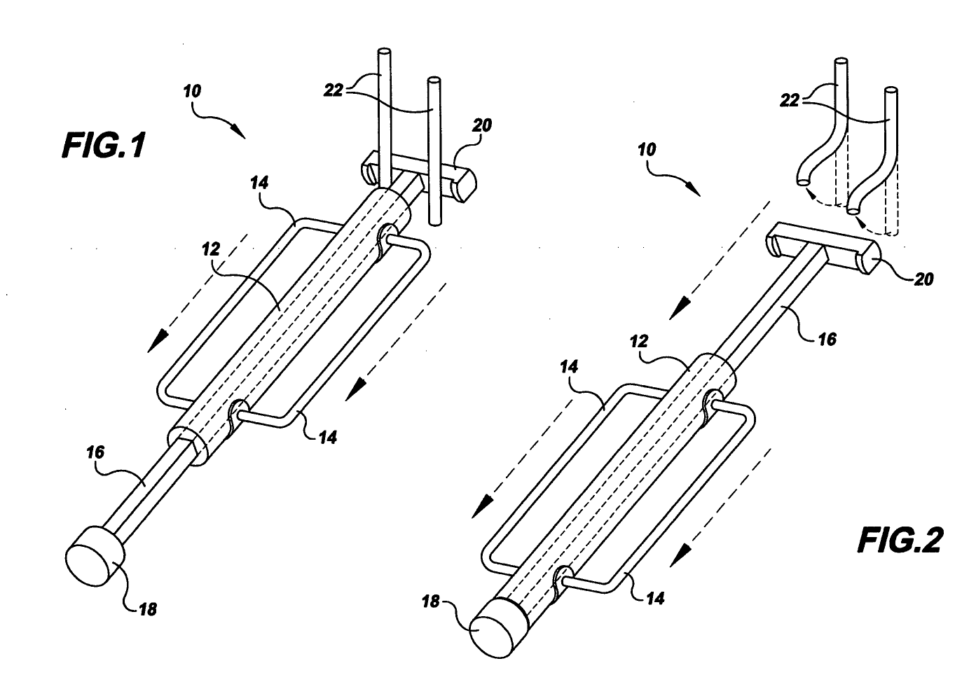

Turning now to FIG. 1, a perspective view of an embodiment of apparatus 10 is illustrated with a two-sided hammerhead 20 relative to burglar bars 22, apparatus 10 ready for use. In an exemplary, non-limiting embodiment such as illustrated in FIG. 1, the apparatus 10 may include a two-sided hammerhead 20, guide rod 16, striking base 18, and guide case 12. Guide case 12 may have one or more handles 14. While the two sides of the two-sided hammerhead 20 may be directly opposite, this not a strict requirement as one side may be off-axis compared with the other (not shown).

The two-sided hammerhead 20 may be inserted between barrier bars and the apparatus 10 rotated so that two-sided hammerhead 20 is engaged with any portion of a burglar bar entry barrier and secured behind the barrier bars (e.g., 22) for leverage, away from the remainder of apparatus 10, as illustrated in FIG. 1. The lateral breadth of the hammerhead's 20 two sides, extending two directions from guide rod 16, enables rapid and secure positioning of the tool and engagement of the hammerhead 20 in a manner that ensures the tool will not be easily or unintentionally disengaged until a barrier is breached, despite rapid, forceful and even violent use of apparatus 10. This two-sided hammerhead apparatus 10 offers positional stability over breaching tools with just one side that may need to be repositioned after each movement or strike with a tool against a barrier.

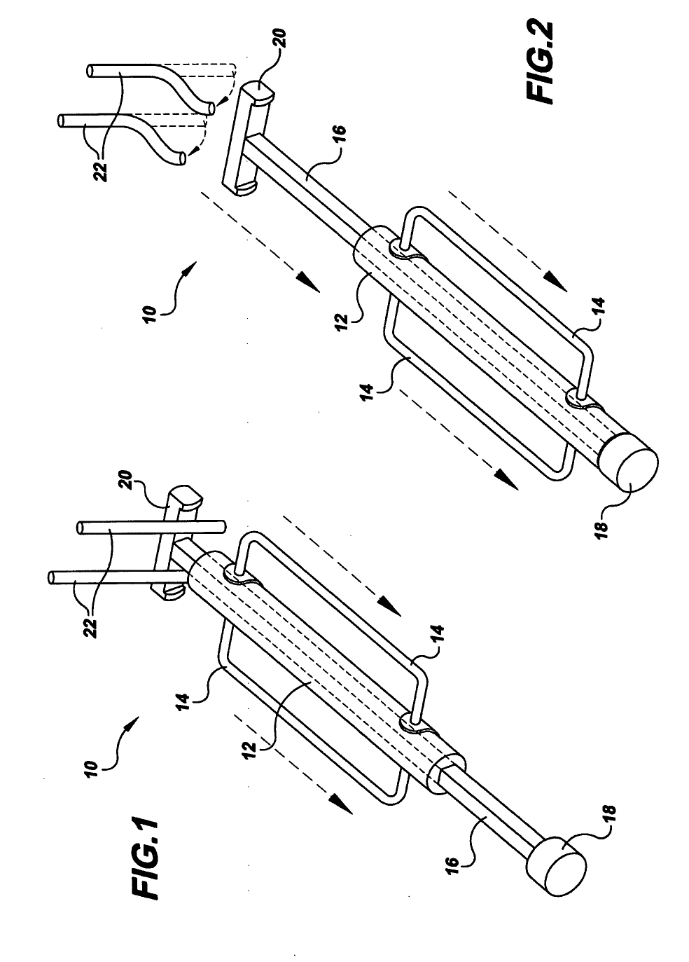

Additionally, one or each side of hammerhead 20 may have protrusions or extensions (see 24 in FIG. 9 and FIG. 10) distal on one or both hammerhead sides from the guide rod 16 extending generally toward the strike base 18. Protrusions 24 in hammerhead 20 also aid in keeping the apparatus 10 engaged with the barrier 22 until breach occurs.

After hammerhead 20 is engaged with an entry barrier (e.g., in behind and/or in contact with bars 22), guide case 12 (having attached guide handles 14) is positioned proximal to the hammerhead 20 along the guide rod 16. The guide case 12, held by the handles, is then rapidly and forcefully moved by one or more users along the guide rod 16 in a motion as illustrated by the arrows (see FIG. 2) away from hammerhead 20, towards and striking the striking base 18. This movement of the guide case 12 in combination with striking the striking base 18 (especially with rapid, forceful and repeated movements by dedicated personnel) will cause a mechanical advantage and leverage over any attached locks, welds, bolts and bars by breaking them or disrupting the attachments, fixtures or frame members holding any entry barriers. This mechanical advantage leads to the breach of entry barriers and allows forced entry into a structure. A secondary use of this tool can be used to breach (e.g., by ramming) a secondary interior door, by striking the door with the tool.

In one embodiment, the apparatus 10 may be constructed of welded steel. In other embodiments the apparatus or component parts may be constructed of non-ferrous or spark-resistant materials, or the components plated or coated with a non-ferrous or spark-resistant material thereby making spark generation less likely during use. It may be desirable to reduce the risk of creating a spark and possibly ignite fumes when breaching a barrier in an area with combustible fumes in the air. For example, a methamphetamine lab in a residence utilizes potentially explosive quantities of an assortment of flammable chemicals.

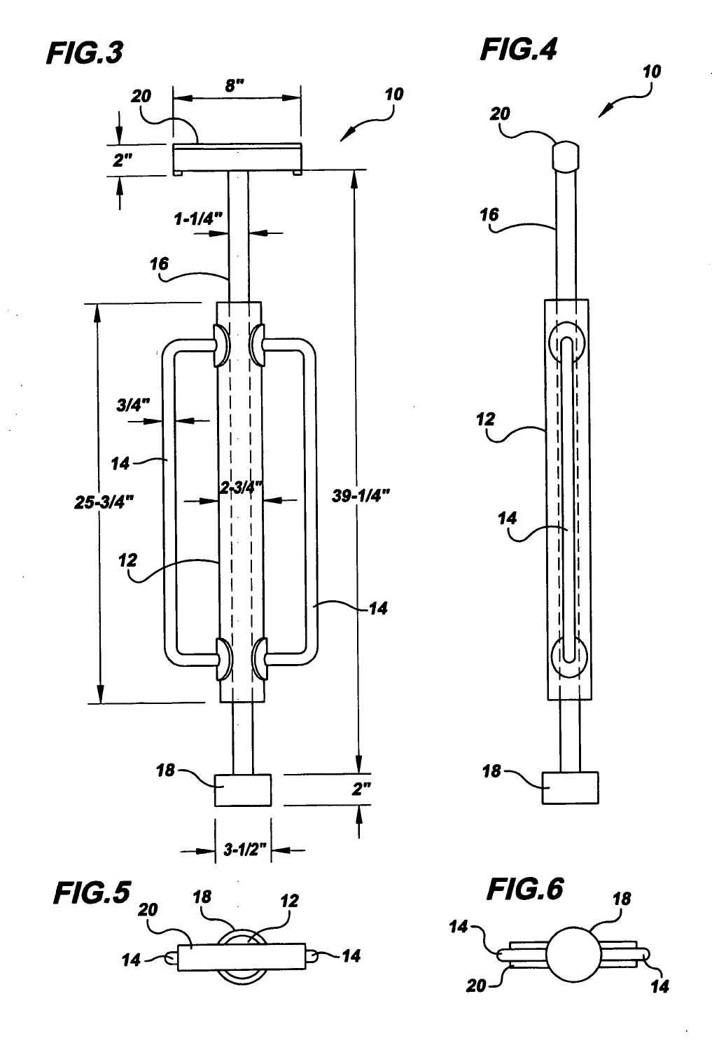

Apparatus 10 may be made in differing embodiments by shortening, lengthening or modifying any component of the apparatus to create a ‘hammerhead’ forcible entry or barrier breaching tool that operates substantially as the embodiments illustrated herein. It will be appreciated that the dimensions illustrated as examples in FIG. 3 are only suggestions. Obvious modifications will be apparent that still allow for an apparatus having a two-sided hammerhead component that remains engaged during use with a multiple bar type entry barrier until breach without undue difficulty and time consuming repositioning.

In another particular embodiment, FIG. 4 illustrates a side elevation view of apparatus 10. In still another particular embodiment, FIG. 5 illustrates a top plan view. And in yet another embodiment, FIG. 6 illustrates a bottom plan view of apparatus 10.

In one non-limiting embodiment, apparatus 10 comprises an elongated guide rod 16 having a hammerhead 20 secured to one end and striking base secured at or near the other end of guide rod 16, distal or opposite hammerhead 20. A guide case 12 surrounding a guide rod 16 has a length less than the guide rod 16. The length of guide rod 16 relative to the length of the guide case 12 may be chosen of sufficient length that users may generate momentum by rapid movement of the guide case 12 relative to the guide rod 16 that will impart significant force to the striking base, thereby transferring potentially barrier-disruptive force to hammerhead 20. It will be appreciated that the disruptive force imparted to the hammerhead 20 may be used in either a forward or rearward direction to disrupt entry barriers or entry barrier attachments.

In another embodiment, guide case 12 may be made of suitably heavy plate metal, and have one or more handles 14 attached. The guide case 12 and attached handle(s) 14 may be of sufficient weight that rapid movement of the case and handle combination will produce momentum leading to a significant exchange or impartation of kinetic energy when the guide case 12 strikes the striking base 18 or the hammerhead 20.

Guide rod 16 and guide case 12 may be any suitable shape, for example both the guide and rod together may be round or square. The guide rod 16 and guide case 12 combination may be appropriately beveled or otherwise shaped such that rotation by the guide case 12 around the guide rod 16 is inhibited, but the guide case 12 sliding parallel to the length of the guide rod 16 is easily enabled.

In several embodiments, a guide rod 16 has a shape that inhibits rotation of the guide case 12 relative to the guide rod 16, but does not inhibit the guide case 12 sliding easily along the guide rod 16. An example includes an embodiment where a square guide case 12 will surround a square guide rod 16. This is a particular embodiment of the case where the rod 16 and case 12 share the same shape combination to inhibit rotation, that is, when the inside shape of the guide case 12 may be substantially the same as the outside of the guide rod 16.

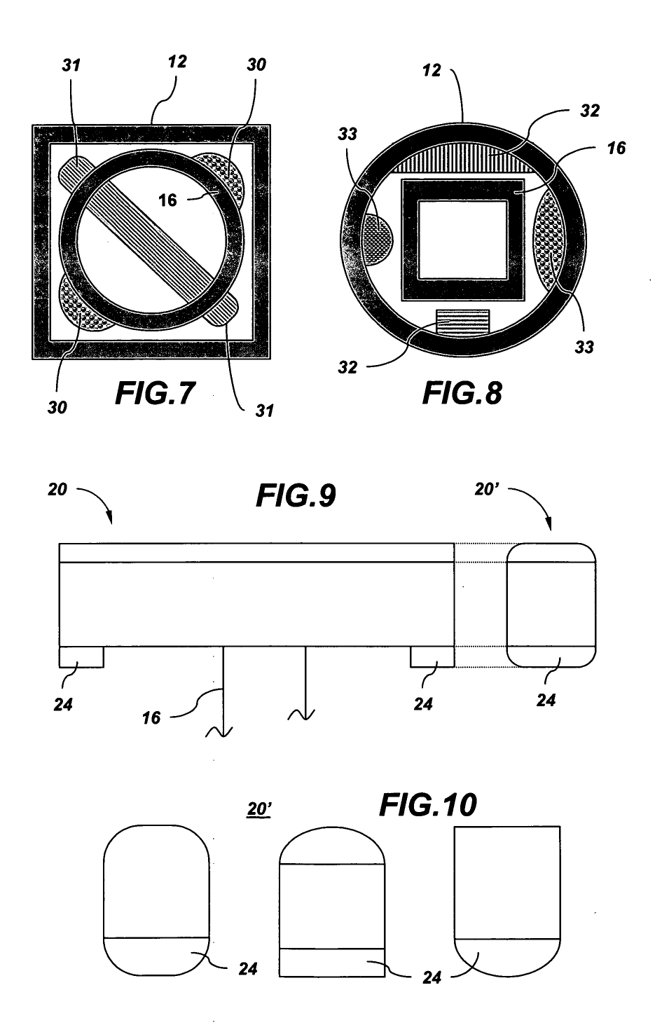

However, it will be appreciated that for some embodiments of the apparatus that rotation may be inhibited without a particularly close match between the inside shape of the guide case and the outside shape of the guide rod. For example as illustrated in FIG. 7, a square guide case 12 may fit slidably over a round guide rod 16, wherein the guide rod has two or more surface protrusions (e.g., 30 or 31) attached to guide rod 16 that inhibit guide case rotation. The surface protrusions may be discreet ‘bumps’ that are positioned parallel lengthwise along the rod or protrusions that extend in the lengthwise direction along the rod outside surface. In another embodiment, the protrusions 30 or equivalent may extend lengthwise parallel to the guide rod 16. In still another particular embodiment, bolts 31 extending across and through the guide rod 16 will also serve to effect protrusions to inhibit case 12 rotation relative to guide rod 16. Bolts may be positioned in parallel and/or at 90 degrees to any other bolt, and thereby largely inhibit the guide case 12 from rotating relative to the guide rod 16 while enabling easy movement parallel to the guide rod 16.

FIG. 8 illustrates an embodiment with a round guide case 12 with a square guide rod 16. Protrusions attached to the guide case 12 inhibiting case rotation relative to the guide rod 16 may be positioned near one or both of the distal ends of the guide case 12 or 10 run lengthwise parallel to the guide rod 16 and are attached to the inside of the guide case 12. Non-exclusive optional protrusion barriers that may be attached to guide case 12 are illustrated in FIG. 8 by 32, 33, 34 or 35, at least two of which may be positioned on opposite sides of guide case 12, and which may be used to inhibit case rotation relative to the rod while enabling easy guide case 12 movement parallel to the guide rod 16. The protrusions may be discreet ‘bumps’ in the lengthwise direction and/or run lengthwise parallel to the guide rod or case.

Two handles 14 are shown attached and symmetrically opposed in FIG. 1 and FIG. 2. When the embodiment illustrated with two handles is used by persons on either side of the apparatus 10 after inserting the hammerhead 20 between bars, any non-rotational inhibition enablement between the guide rod 16 and guide case 12 enables the hammerhead 20 to remain in proximity to the entry barrier until the barrier is breached.

It will be appreciated that a handle 14 does not need to be positioned diametrically opposite another handle.

FIG. 9 is plan view of a two-sided hammerhead 20 with protrusions 24 distal from guide rod 16, the protrusions 24 extending toward striking base. This plan view of hammerhead 20 may be compared to a profile view also in FIG. 9 of a hammerhead 20′. FIG. 10 illustrates optional profile views 20′ for a hammerhead component with optional protrusions 24 that extend toward the striking base 18. As illustrated by the profile views of FIG. 9 and FIG. 10, the ‘top’ of the hammerhead 20′ on the opposite side of where guide rod 16 is attached, the top may be rounded, partially rounded or substantially flat. Likewise the profile views of FIG. 9 and FIG. 10 illustrate that protrusion 24 may be rounded, partially rounded or substantially flat.

FIG. 11 illustrates a locking pin 42, which may be a pin, screw or bolt, to secure the guide case to the guide rod. The guide case 12 may be secured to the guide rod 16 by a locking pin 42 so that the guide case 12 does not slide relative to the hammer head making apparatus 10 easier to use as a battering tool and more conveniently secured during storage. The locking pin may be engaged in the secured position when the guide case 12 is adjacent to the striking plate 18. While the pin or bolt position 44 is shown relatively close to the striking plate 18, the pin or bolt position 44 may be any place along the guide case 12. The locking pin may extend through the guide case and the guide rod, partially through the guide rod, or not through the guide rod and/or held by pressure with a threaded locking pin shaft. The locking pin 42 may also have a cotter pin for added security. The locking pin shaft 42 may be threaded, grooved or unthreaded, and the locking pin head 40 may be of various shapes for handling, for example rounded, octagonal or winged.

In one embodiment a forcible entry tool to breach metal bars or burglar bars attached to structures includes a guide rod with a guide case slidably disposed around the guide rod. A two-sided hammerhead attached is to a first end of the guide rod and a striking base is attached near a second end of the guide rod. One or more handles may be attached to the guide case.

Another embodiment of the invention includes extending the hammerhead's two sides in opposite directions normal or perpendicular to the guide rod. In still another embodiment, the two sides of the hammerhead may be angled relative to being diametrically opposed. The two sides of the hammerhead may be symmetrical or not. An embodiment includes a protrusion or extension on one or both sides of the hammerhead, wherein the protrusion is a portion of the hammerhead distal from the guide rod and extending toward the striking base. This extension aids in keeping the hammerhead in position.

In another embodiment the top or front side of the hammerhead (opposite where the hammerhead is attached to the guide rod) may be substantially flat. In still another embodiment, the top or leading edge of the hammerhead may be curved. An embodiment of the forced entry tool includes making the entire tool from a non-ferrous metal. Other embodiments include any or all of the parts being plated or coated with a non-ferrous material. In still another embodiment, the guide case may be secured to the guide rod by a locking pin that may be threaded and may extend through the guide case and guide rod.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. An apparatus for breaching burglar bars comprising:
(a) a two-sided hammerhead;
(b) a guide rod;
(c) a guide case;
(d) a guide handle; and
(e) a striking base.

2. The apparatus of claim 1 wherein the two sides of the hammerhead extend in two directions normal to the guide rod.

3. The apparatus of claim 1 wherein at least one side of the hammerhead further comprises a protrusion, wherein the protrusion is a portion of the at least one side of the hammerhead distal from the guide rod extending toward the striking base.

4. The apparatus of claim 1 wherein the two sides of the hammerhead are symmetrically shaped.

5. The apparatus of claim 1 wherein the hammerhead further comprises at least one selected from the list consisting of i) a substantially flat surface distal from the striking base, and ii) a substantially curved surface distal from the striking base.

6. The apparatus of claim 1 further comprising a locking pin to secure the guide case to the guide rod.

7. The apparatus of claim 1 wherein at least one of the list consisting of: i) the two-sided hammerhead, ii) the guide rod, iii) the guide case; iv) the guide handle and v) the striking base is made from a non-ferrous metal.

8. The apparatus of claim 1 wherein at least one of the list consisting of: i) the two-sided hammerhead, ii) the guide rod, iii) the guide case; iv) the guide handle and v) the striking base is plated with a non-ferrous material.

9. A forcible entry tool to breach metal bars attached to structures comprising:
(a) a guide rod;
(b) a guide case slidably disposed around the guide rod;
(c) a two-sided hammerhead attached to a first end of the guide rod;
(d) a guide handle attached to the guide case; and
(e) a striking base attached near a second end of the guide rod.

10. The forcible entry tool of claim 9 wherein the two sides of the hammerhead extend in two directions normal to the guide rod.

11. The forcible entry tool of claim 9 wherein at least one side of the hammerhead further comprises a protrusion, wherein the protrusion is a portion of the at least one side of the hammerhead distal from the guide rod extending toward the striking base.

12. The forcible entry tool of claim 9 wherein the two sides of the hammerhead are symmetrically shaped.

13. The forcible entry tool of claim 9 wherein the hammerhead further comprises at least one selected from the list consisting of i) a substantially flat surface distal from the striking base, and ii) a substantially curved surface distal from the striking base.

14. The forcible entry tool of claim 9 further comprising a locking pin to secure the guide case to the guide rod.

15. The forcible entry tool of claim 9 wherein at least one of the list consisting of: i) the two-sided hammerhead, ii) the guide rod, iii) the guide case; iv) the guide handle and v) the striking base is made from a non-ferrous metal.

16. The forcible entry tool of claim 9 wherein at least one of the list consisting of: i) the two-sided hammerhead, ii) the guide rod, iii) the guide case; iv) the guide handle and v) the striking base is plated with a non-ferrous material.

17. A forcible entry tool to breach metal bars comprising:
(a) a guide rod;
(b) a guide case slidably disposed around the guide rod, wherein the guide case has at least one handle attached;
(c) a two-sided symmetrically shaped hammerhead attached to a first end of the guide rod; and
(d) a striking base attached near a second end of the guide rod.

18. The forcible entry tool of claim 17 further comprising a plurality of handles attached to the guide case.

19. The forcible entry tool of claim 17 further comprising a protrusion, wherein the protrusion is a portion of the at least one side of the hammerhead distal from the guide rod extending toward the striking base.

20. The forcible entry tool of claim 17 wherein at least one of the list consisting of: i) the two-sided hammerhead, ii) the guide rod, iii) the guide case; iv) the guide handle and v) the striking base is plated with a non-ferrous material.
